(19) United States
(12) Patent Application Publication
(10) Pub. No.: US 2005/0106293 A1
(43) Pub. Date: May 19, 2005

(54) Foodstuff packages

(76) Inventor: Thomas Bruckner, Hamburg (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/954,409

(22) Filed: Sep. 30, 2004

Related U.S. Application Data
(62) Division of application No. 09/637,568, filed on Aug. 11, 2000, now abandoned.

(30) Foreign Application Priority Data
Aug. 13, 1999 (DE) 299 14 219.1

(51) Int. Cl. C12C 1/027

(52) U.S. Cl. 426/106

(57) ABSTRACT

A foodstuff package chain comprising several releasably interconnected bags which contain a fill of desiccated foodstuffs, are permeable to liquid, and enable the desiccated foodstuffs to swell and/or be boiled in a water bath.

### CROSS-REFERENCE TO RELATED APPLICATIONS

This application is a divisional of application Ser. No. 09/637,568 filed Aug. 11, 2000, and the entire contents of which are hereby incorporated by reference.

### STATEMENT REGARDING FEDERALLY SPONSORED RESEARCH

Not Applicable

### BACKGROUND OF THE INVENTION

The invention relates to foodstuff packages, namely a foodstuff package chain and a foodstuff package.

It has been known already to supply desiccated vegetables to large-scale consumers. Drying the vegetables saves storage space and weight in transport. The consumer removes the foodstuff volume he needs and soaks them in order to re-feed the water withdrawn. After rehydration, the vegetables will also be cooked in case of need. This procedure is expensive because it requires to measure the volume, place the portion in a water bath, and separate it from the bath subsequently.

Likewise, it has been known already to bag the dehydrated vegetable in measured volumes. However, this requires to rip the bag open, fill the dehydrated vegetable into a vessel filled with water and separating it from the water subsequently. It is difficult to separate the rehydrated product from the water by this method: separation is time-consuming and there is a risk of contamination and product loss.

Ultimately, a foodstuff package has been known already which contains a fill of dehydrated foodstuffs, is permeable to liquid, and makes it possible to swell and/or boil the dehydrated foodstuffs in a water bath. By simply placing the bag in a sufficiently dimensioned water bath and swelling or boiling it subsequently, a precisely matched foodstuff volume of is obtained in a fresh condition for further preparation. Any harm to foodstuffs which are susceptible to break may be avoided to a large extent. In addition, the foodstuff may be made available in a precisely portioned condition in the bags. The former withdrawal of a part of the volumes from cardboard boxes or bags becomes unnecessary.

Each of the bags is filled with a predetermined volume of foodstuff. If major volumes are needed an appropriate number of bags has to be resorted to. It is problematic to handle a multitude of individual bags. Although it is possible to withdraw a part of the volume from the bags it involves the above mentioned problems.

The bags which are known are made of a perforated plastic material. As a result, it is hardly possible to apply a marking or inscription on the bags. Moreover, small-sized foodstuffs or abraded particles might exit through the holes of the bag. Ultimately, plastic bags are considered to be harmful environmentally.

Accordingly, it is an object of the invention to provide a foodstuff package chain and a foodstuff package having improved properties in manufacture and use.

### BRIEF SUMMARY OF THE INVENTION

The inventive foodstuff package chain comprises several releasably interconnected bags which contain a fill of desiccated foodstuffs, are permeable to liquid, and make it possible to swell and/or boil the desiccated foodstuffs in a water bath. This permits to easily portion them according to needs by tearing off the number of bags required and to introduce them into a water bath. To this end, for example, three easy-to-separate bags each containing 100 g of desiccated vegetables may be made available rather than one bag containing 300 g. The bags joined to each other may advantageously be handled together, which makes it easier to avoid product abrasion and improves product safety altogether. Furthermore, it simplifies packaging the foodstuff package chain in an enclosing cardboard box.

### BRIEF DESCRIPTION OF THE SEVERAL VIEWS OF THE DRAWINGS

The invention will now be explained with reference to embodiments shown in the drawings.

FIG. 1 shows a perspective view of the inventive foodstuff package chain.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

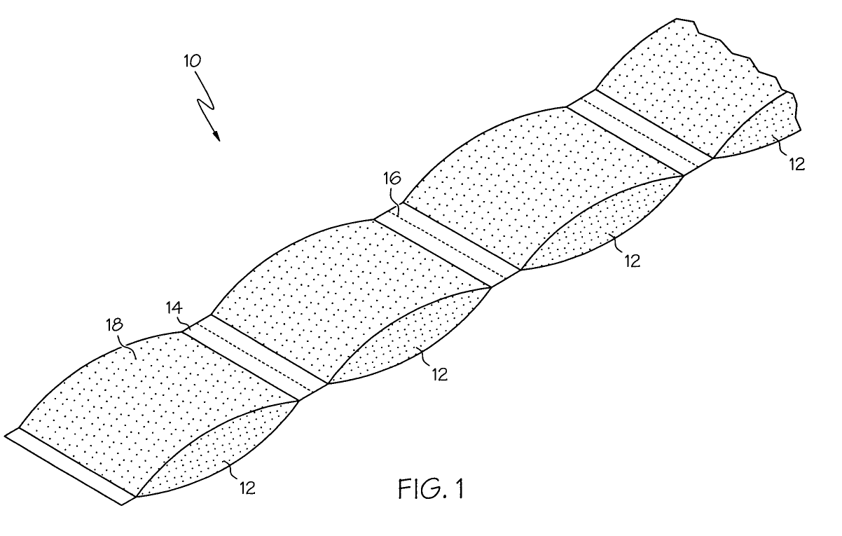

Referring now to FIG. 1, the inventive foodstuff package chain is shown generally at 10. Foodstuff package chain 10 is composed of a plurality of bags 12 joined together by transverse sealing seams 14, which include weakening lines 16. The bags 12 include perforations 18.

Preferably, the bags may be made up from a water-permeable film material. The bags may be marked off from each other by transversely directed sealing seams in a tubing of the film material. The tubing further may be formed from a continuous web of a film material the edges of which are interconnected by a transversely directed sealing seam.

Preferably, the bags may be separable from each other along weakening lines which extend across the connections between the bags. These may be perforated lines introduced into a film material. Each of them may be disposed between several transversely directed sealing seams which are left on various bags following the separation of two adjoining bags.

In particular, a water-permeable plastic film may be used for the film material of the foodstuff package chain and preferably can be a perforated plastic film.

A film material which is contemplated here, for example, is one having 250 to 750 perforations per dm², particularly about 400 to 450 perforations per dm².

The diameter of the perforations may preferably be in the range from 0.5 to 2.5 mm, particularly in the range from 1.2 to 1.7 mm.

Preferably, the plastic film may have a thickness of 10 to 100 μm, particularly 20 to 30 μm.

The plastic film concerned may be a polypropylene film or a polyethylene film. In particular, an OPP flat film is contemplated here which is offered, for example, by the Maack GmbH of 58612 Iserlohn under the article No. 12415 P 00002.

The inventive foodstuff package, which specifically may form part of a foodstuff package chain of the initially mentioned type, has a bag made from a non-woven fabric which contains a fill of desiccated foodstuffs, is permeable to liquid, and makes it possible to swell and/or boil the desiccated foodstuffs in a water bath. The non-woven fabric preferably may be a long-fibred paper.

Such non-woven fabrics are in use already as tea bags and, therefore, are known as “tea bag paper”. What is surprising is their ability to be employed for a foodstuff package or foodstuff package chain to swell and/or boil foodstuffs.

The non-woven fabric allows liquid to enter, but prevents small-sized foodstuffs or abraded particles from exiting. The nature of the foodstuff package also makes it impossible for foreign bodies or impurities to get into the product, which is an additional contribution to product safety.

What is also advantageous is the good printability of the non-woven fabric, which specifically allows to print a marking or instructions for use thereon.

Another advantage which should be mentioned is the increased environmental acceptability of the non-woven fabric.

Another advantageous feature is the improved ability of the non-woven fabric to be ripped open, which facilitates product withdrawal after the swelling and/or cooking process.

Preferably, a non-woven fabric having a basis weight by grams (“grammature”) of 10 to 50 g/m² may be employed. The thickness of the non-woven fabric may specifically be in the range from 50 to 200 μm.

Suitable non-woven fabrics are marketed, for example, by the Crompton Company under the name “Super-Siegel Teebeutelpapier” of the grade Referenz 473701 or 473702. Preferably, a non-woven fabric (long-fibred paper) of Schoeller & Hoesch GmbH & Co. KG of D-76584 Gernsbach may be used which is marketed under the product name Dynapore® Vliespapier heiβsiegelfähig 135/2LCU (grammature 35.0 g/m²).

The fill of the foodstuff package chain or foodstuff package may be a cut or piece-cut foodstuff.

The fill may contain a vegetable or mixed vegetables and/or potatoes or mixed potatoes. It further may include onions and/or garlic. The potatoes may be blanched, cut to pieces, and desiccated.

The fill further may include lettuce or mixed lettuces and/or mushrooms or mixed mushrooms and/or herbs or mixed herbs.

In addition, the fill may include fruits or mixed fruits.

Finally, the fill may include mixed spices.

The foodstuff package is particularly suited for particularly small-sized foodstuffs of the aforementioned type.

The above Examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

1. Method for preparing a desired portion of foodstuff from a supply of dehydrated foodstuff comprising the following steps:
providing a foodstuff package chain comprising several releasably interconnected bags made from a non-woven fabric which contain in each bag a fill of dehydrated foodstuffs, are permeable to liquid, and enable the dehydrated foodstuffs to swell in a water bath,
separating the number of bags corresponding to a desired portion of foodstuff from the foodstuff package chain,
swelling the dehydrated foodstuff by introducing the separated number of bags into a water bath, and
withdrawing the portion of foodstuff from the separated number of bags after the swelling in the water bath.

2. The method of claim 1 wherein the bags are made up from a water-permeable film material.

3. The method of claim 2 wherein the bags are marked off from each other by transversely directed sealing seams in a tubing of the film material.

4. The method of claim 3 wherein the tubing may be formed from a continuous web of a film material the edges of which are interconnected by a transversely directed sealing seam.

5. The method of claim 1 wherein the bags are separable along weakening lines which extend across the connections between the bags.

6. The method of claim 3 wherein there are several transversely directed sealing seams between two adjoining bags each.

7. The method of claim 1 wherein the bags have a weakened region and/or a worked-in perforation line.

8. A method, particularly a method of claim 1 containing a bag made from a non-woven fabric which contains a fill of dehydrated foodstuffs, is permeable to liquid, and makes it possible to swell and/or boil the dehydrated foodstuffs in a water bath.

9. A method of claim 8 wherein the non-woven fabric has a basis weight of 10 to 40 g/m².

10. A method of claim 8 wherein the non-woven fabric has a thickness of 50 to 150 μm.

11. The method of claim 8 which is filled with a small-sized dehydrated foodstuff.

12. The method of claim 8 which has an imprint applied thereon.

13. The method of claim 8 which is filled with 50 to 500 g of a dehydrated foodstuff.

14. The method of claim 8 which has a weakened portion and/or a worked-in cord which serve(s) as a rip-open aid.
